(19) United States
(12) Patent Application Publication
(10) Pub. No.: US 2006/0254612 A1
(43) Pub. Date: Nov. 16, 2006

(54) Polar fluid removal from surfaces using supercritical fluids

(75) Inventor: Paul A. Farrar, Bluffton, SC (US)

Correspondence Address: MUETING, RAASCH & GEBHARDT, P.A., P.O. BOX 581415, MINNEAPOLIS, MN, 55458, US

(73) Assignee: MICRON TECHNOLOGY, INC., Boise, ID (US)

(21) Appl. No.: 11/130,011

(22) Filed: May 16, 2005

(51) Int. Cl. B08B 6/00; B08B 7/04; B08B 3/00

(52) U.S. Cl. 134/1.1; 134/26; 134/10

(57) ABSTRACT

A method for removing polar fluids from the surface of a substrate using a supercritical fluid is described. Substrates that may be cleaned include microelectronic devices such as integrated circuits, micro-electro mechanical devices, and optoelectronic devices. The surfaces of these devices may include foamed polymers, such as those used as dielectric material. Supercritical fluids useful for removal of polar fluids generally include an oxygen-containing organic compound in the supercritical state. The removal of polar fluids using supercritical fluids may be supplemented by other cleaning methods using supercritical fluids to remove particulate matter from the surface of the substrate.

### FIELD OF THE INVENTION

The inventions relates to methods of cleaning a surface using supercritical fluids. More specifically, the invention relates to methods of removing polar fluids from the surface of porous and non-porous materials present in microelectronic devices.

### BACKGROUND

The development of high-density ultra large scale integrated (ULSI) circuits with sub-micron dimensions has led to the need to remove unwanted contaminants from the surface of the wafers used in the production of these devices. Removal becomes especially difficult in the case of the trench in the trench capacitor, or the deep contacts necessitated by the use of the stacked capacitor in DRAMS or the use of the damascene process in the production of copper metallurgy. There are four types of materials that must be removed; the first is the residuals left from a film, all or a portion of which is to be removed. The most notable of these materials is photo-resist. The second type of materials are incidental contaminates. The third type of materials are particles of film that are deposited incidentally to the deposition of the film layer. The fourth type is water, which may be adsorbed onto the surface or in the pores of the materials used to construct the semiconductor, especially for polymers and polymer foams.

Producing integrated circuits on a silicon wafer requires several hundred separate steps, which generally take a month or more to complete. A large portion of these steps are cleaning steps. After many operations, the wafer is run through either a sequence of acid solutions or de-ionized water to remove any particles or impurities that may have formed. These processes are one reason wafer fabrication consumes so much water; wafer production facilities often consume between two million and five million gallons per day. Water may be attached to the surface by chemical or physical attachment, depending upon what other contaminants may be present. The minimum dimensions from which water must be removed has continued to decrease as the minimum feature size has decreased. This has been aggravated by the fact that the vertical dimensions have not tended to shrink as fast as the horizontal dimensions, thus making relatively deep holes for contaminates and requiring smaller pore sizes in foam insulators.

One method used to remove water from surfaces such as integrated circuit wafers is to heat the wafer. This may cause problems, however, since if the surface is not completely clean, then stains may be formed. With foamed polymers or inorganic materials with connecting pores, the time at temperature necessary to remove the unwanted contaminate may be very long, and the foamed polymer may be damaged by high temperatures. As an alternative to heat, chemical solvents have been used to dissolve the unwanted particles and organic liquids; however, these were generally not effective for removing unwanted polar contaminants such as water. Furthermore, while organic solvents can usually dissolve and extract objectionable components such as water, vestiges of these solvents are themselves often difficult to remove without degrading or altering the characteristics of the substrate, particularly for polymeric substrates. Water, which is the most common polar contaminant, is particularly a problem when adsorbed in porous insulator structures, as it tends to increase the effective dielectric constant of the material, rendering it less effective as an insulator.

### SUMMARY OF THE INVENTION

The present invention provides a method of cleaning a surface of a substrate that includes contacting the substrate with a solvation fluid comprising an oxygen-containing organic compound in a supercritical state and returning the oxygen-containing organic compound to a non-supercritical state to remove at least a portion of a polar fluid present on the surface of the substrate.

Embodiments of the invention include various surfaces that may be cleaned by the method. For example, the surface may be a porous material. Preferably, the porous material has a maximum cell size of at most about 0.3 microns. The surface may also include a polymer layer. Preferably, the polymer layer includes a foamed polymer. The substrate itself is preferably a microelectronic substrate. Preferably, the polar fluid removed by the method is water.

In further embodiments of the method, the oxygen-containing organic compound may be returned to a non-supercritical state by reducing its pressure. In another embodiment, the oxygen-containing organic compound is returned to a non-supercritical state by reducing its temperature. In yet further embodiments, the oxygen-containing organic compound is an alcohol or an ether. Preferably, the oxygen-containing organic compound includes an ethyl alcohol, methyl alcohol, or ethyl ether, with ethyl alcohol being particularly preferred.

Additional embodiments of the method include drying the surface of the substrate after returning the oxygen-containing organic compound to a non-supercritical state and/or delivering sonic wave energy to the substrate.

The invention also provides a method of cleaning a porous surface of a microelectronic substrate that includes contacting the microelectronic substrate with a solvation fluid that includes an oxygen-containing organic compound in a supercritical state and returning the oxygen-containing organic compound to a non-supercritical state to remove at least a portion of a polar fluid present on the porous surface of the microelectronic substrate. Preferably, the oxygen-containing organic compound includes ethyl alcohol, methyl alcohol, or ethyl ether.

The invention also provides a method of cleaning a surface of a substrate that includes placing the substrate in contact with a stripping fluid, contacting the substrate or stripping fluid with cleaning fluid in a supercritical state, returning the cleaning fluid to a non-supercritical state to remove at least a portion of a waste material present on the surface of the substrate, contacting the substrate with a solvation fluid comprising an oxygen-containing organic compound in a supercritical state, and returning the oxygen-containing organic compound to a non-supercritical state to remove at least a portion of a polar fluid present on the surface of the substrate.

In embodiments of this method, the cleaning fluid includes carbon dioxide, ethane, ethylene, nitrous oxide, propane, or xenon. In further embodiments, the stripping fluid includes sulfuric acid solution, hydrogen peroxide solution, or de-ionized water. In an additional embodiment, the substrate is dried before contacting the substrate with a solvation fluid.

Embodiments of this method include various surfaces that may be cleaned by the method. For example, the surface may be a porous material. Preferably, the porous material has a maximum cell size of at most about 0.3 microns. The surface may also include a polymer layer. Preferably, the polymer layer includes a foamed polymer. The substrate itself is preferably a microelectronic substrate. Preferably, the polar fluid removed by the method is water. Additional embodiments of the method include delivering sonic wave energy to the substrate.

Embodiments of this method of cleaning a porous surface of a microelectronic substrate also include contacting the microelectronic substrate with a solvation fluid that includes an oxygen-containing organic compound in a supercritical state and returning the oxygen-containing organic compound to a non-supercritical state to remove at least a portion of a polar fluid present on the porous surface of the microelectronic substrate. Preferably, the oxygen-containing organic compound includes ethyl alcohol, methyl alcohol, or ethyl ether, with ethyl alcohol being particularly preferred.

The invention also provides a method of cleaning a porous surface of a microelectronic substrate that includes placing the microelectronic substrate in contact with a stripping fluid, contacting the substrate or the stripping fluid with cleaning fluid in a supercritical state, returning the cleaning fluid to a non-supercritical state to remove at least a portion of a waste material present on the porous surface of the microelectronic substrate, drying the microelectronic substrate, contacting the microelectronic substrate with a solvation fluid comprising an oxygen-containing organic compound in a supercritical state; and returning the oxygen-containing organic compound to a non-supercritical state to remove at least a portion of a polar fluid present on the porous surface of the microelectronic substrate.

In embodiments of this method, the cleaning fluid includes carbon dioxide, ethane, ethylene, nitrous oxide, propane, or xenon. In further embodiments, the stripping fluid includes sulfuric acid solution, hydrogen peroxide solution, or de-ionized water. In an additional embodiment, the substrate is dried before contacting the substrate with a solvation fluid.

The invention also provides a method of cleaning a surface of a substrate that includes contacting the substrate with a gaseous plasma, contacting the substrate with cleaning fluid in a supercritical state, returning the cleaning fluid to a non-supercritical state to remove at least a portion of a waste material present on the surface of the substrate, contacting the substrate with a solvation fluid comprising an oxygen-containing organic compound in a supercritical state, and returning the oxygen-containing organic compound to a non-supercritical state to remove at least a portion of a polar fluid present on the surface of the substrate. The gaseous plasma may include an oxidizer selected from the group consisting of SO₂, N₂O, NO, NO₂, O₃, H₂O₂, F₂, Cl₂, Br₂, and O₂.

Embodiments of this method include various surfaces that may be cleaned by the method. For example, the surface may be a porous material. Preferably, the porous material has a maximum cell size of at most about 0.3 microns. The surface may also include a polymer layer. Preferably, the polymer layer includes a foamed polymer. The substrate itself is preferably a microelectronic substrate. Preferably, the polar fluid removed by the method is water. Additional embodiments of the method include delivering sonic wave energy to the substrate.

Embodiments of this method of cleaning a porous surface of a microelectronic substrate also include contacting the microelectronic substrate with a solvation fluid that includes an oxygen-containing organic compound in a supercritical state and returning the oxygen-containing organic compound to a non-supercritical state to remove at least a portion of a polar fluid present on the porous surface of the microelectronic substrate. Preferably, the oxygen-containing organic compound includes ethyl alcohol, methyl alcohol, or ethyl ether, with ethyl alcohol being particularly preferred.

The invention also provides a method of cleaning a porous surface of a microelectronic substrate that includes contacting the microelectronic substrate with a gaseous plasma, contacting the microelectronic substrate with cleaning fluid in a supercritical state, returning the cleaning fluid to a non-supercritical state to remove at least a portion of a waste material present on the porous surface of the microelectronic substrate, contacting the microelectronic substrate with a solvation fluid comprising an oxygen-containing organic compound in a supercritical state, and returning the oxygen-containing organic compound to a non-supercritical state to remove at least a portion of a polar fluid present on the polar surface of the microelectronic substrate. The gaseous plasma may include an oxidizer selected from the group consisting of SO₂, N₂O, NO, NO₂, O₃, H₂O₂, F₂, Cl₂, Br₂, and O₂.

In invention also provides a composition that includes a microelectronic substrate or microelectronic substrate assembly in contact with a solvation fluid comprising an oxygen-containing organic compound in a supercritical state. In embodiments of this aspect of the invention, the oxygen-containing organic compound includes an alcohol or an ether. In preferred embodiments, the oxygen-containing organic compound includes ethyl alcohol, methyl alcohol, or ethyl ether, with ethyl alcohol being particularly preferred. In yet further embodiments, the microelectronic substrate includes a foamed polymer. Preferably, the foamed polymer has a maximum cell size of at most about 0.3 microns.

### BRIEF DESCRIPTION OF THE FIGURES

FIG. 1A is a cross-sectional representation of a portion of an integrated circuit substrate having polymeric material thereon.

FIG. 1B is a cross-sectional representation of a portion of the substrate of FIG. 1A showing contaminating waste material and polar fluids.

FIG. 2 is a schematic representation of a pressure vessel for use in cleaning a surface in accordance with the invention.

### DETAILED DESCRIPTION OF PREFERRED EMBODIMENTS OF THE INVENTION

Methods and compositions for cleaning the surface of a substrate are described herein. The methods of surface cleaning are illustrated by various embodiments. In one embodiment, polar fluids (e.g. water) present on the surface of a substrate are removed using solvation fluid that contains an oxygen-containing organic compound in a supercritical state. In a second embodiment, waste matter present on the surface of a substrate is removed subsequent to a wet stripping process using a supercritical cleaning fluid. Polar fluids remaining on the surface of the substrate are then removed using supercritical solvation fluids. In a third embodiment, waste matter present on the surface of a substrate is removed subsequent to a dry stripping process using a supercritical fluid. Again, polar fluids remaining on the surface of the substrate are then removed using supercritical solvation fluids. The following description is further illustrative of the various embodiments of the invention.

Supercritical Fluids

The invention includes the use of supercritical fluids for cleaning the surface of a substrate. Supercritical fluids are materials used in the invention primarily when at least one compound in the fluid is in the supercritical state, as will be defined in more detail herein. Supercritical fluids of the invention include both solvation fluids and cleaning fluids. Solvation fluids, which will also be defined in more detail herein, are generally oxygen-containing organic compounds that are used for removing polar fluids. Cleaning fluids are also supercritical fluids used in the invention, described in more detail herein, and are used for the removal of waste material (e.g., particulate residue remaining after photoresist stripping).

Both solvation fluids and cleaning fluids are supercritical fluids capable of being transformed into the supercritical state for use in the invention. A supercritical fluid is a material that may be a liquid or gas at room temperature, used in a state above its critical temperature and pressure where it exists in a phase that exhibits various properties of both liquids and gases, called the supercritical state. For example, a supercritical fluid has the gaseous property of being able to penetrate small spaces, and the liquid property of being able to solvate materials; i.e., dissolve materials into solution. A gas or liquid enters the supercritical state when the combination of its pressure and temperature are above a critical state. This may be achieved by raising the temperature, pressure, or both, depending on starting conditions. For example, for CO₂, the critical temperature is 31° C. and the critical pressure is 7.38 Mpa (72.8 atmospheres). Thus, when CO₂ is subjected to temperatures and pressures at or above 31° C. and 7.38 MPa, it is transformed to a supercritical state, or phase. The critical temperatures and pressures of a number of the fluids that may be used in the present invention are provided in Table 1, below. Further critical temperatures and pressures may be found in the Handbook of Chemistry and Physics, 51^{st} Ed., pages F63-F64.

TABLE I

| | | Critical Temp | Critical Pressure |
|---|---|---|---|
| Formula | Name | T_{c} ° C. | Pc atm. |
| CH₄O | Methanol | 240 | 78.5 |
| C₂H₄ | Ethylene | 9.9 | 50.5 |
| C₂H₆ | Ethane | 32.2 | 48.2 |
| C₂H₆O | Ether, dimethyl | 127 | 52.6 |
| C₂H₆O | Ethanol | 243 | 63 |
| C₃H₈O | Ether, ethyl methyl | 164.7 | 43.4 |
| C₃H₈ | Propane | 96.8 | 42 |
| CO₂ | Carbon Dioxide | 31 | 72.9 |
| N₂O | Nitrous oxide | 36.5 | 71.7 |
| Xe | Xenon | 16.6 | 58 |

Preferably, the temperature of the supercritical fluid used to remove waste material or polar fluids according to the present invention is in the range of about 30° C. to about 250° C. A supercritical fluid generally includes an oxygen-containing organic material, but may contain more than one component. As at least one component of the composition used to remove the organic material, generally the oxygen-containing organic material, must be in a supercritical state, the temperatures used will need to satisfy the critical temperature requirements for the component that exists in the supercritical state in the composition. For example, relatively low temperatures may be achieved by using carbon dioxide as the supercritical component in the composition.

Preferably, the pressure range used to clean substrate surfaces is in the range of about 1 atmosphere to about 250 atmospheres. Again, because at least one component of the composition used to clean the substrate surface, generally the oxygen-containing organic compound, must be in a supercritical state, the pressure used will need to satisfy the critical pressure requirements for the component that exists in the supercritical state in the composition. By using a supercritical component with a lower pressure, lower pressure processing parameters can be achieved.

One advantage of supercritical fluids is that they can quickly penetrate pores or cells on or near the surface of a substrate to remove polar liquids and/or other waste material trapped therein. After solvating at least a portion of the materials present on the surface of the substrate, the supercritical fluid may then be withdrawn, bringing with it the solvated or otherwise carried materials which are thereby removed from the voids or pores in the substrate surface. Removal of waste material from a surface may be facilitated by bubble formation in the supercritical fluid, particularly if the fluid is rapidly removed from the supercritical state. Examples of openings in the surface that can be dried by the method of the invention include pores and voids in an insulation layer, pores and voids in a low-K dielectric material, and gaps in the substrate that may trap polar fluids or other waste material.

As noted herein, a variety of chemicals are capable of entering the supercritical state at readily achievable temperatures and pressures. Use of particular solvents, or combinations of solvents, leads to a variety of different removal characteristics. Further, by varying combinations of pressure and temperature, additional removal characteristics can be obtained. For example, increasing pressure on the supercritical composition causes its density to increase, thus increasing its solvent strength. Increasing the temperature of the supercritical composition normally increases the removal rate of material from the surface of the substrate. The properties of the supercritical fluid can also be modified by the addition of additives, which can be either organic solvents, surfactants, other chemicals like chelating agents, or mixtures thereof. Generally, additives may be used to reduce the pressure necessary for the supercritical fluid to enter the supercritical state or to support the cleaning process. Additives, if used, must be chosen carefully to avoid contaminating the surface being cleaned by the additive.

One skilled in the art will recognize that the various components within a system combined according to a variety of sequences to attain a supercritical fluid composition. For example, a supercritical fluid component, e.g. carbon dioxide in the supercritical state, may be added to a stripping composition such as an H₂SO₄/H₂O₂ solution to form a supercritical fluid. Alternately, carbon dioxide in a non-supercritical state may be added to a stripping composition and the temperature and pressure raised to convert the mixture to one containing a supercritical component. Thus, a component not in a supercritical state may be added to a supercritical fluid either before it is brought to the supercritical state or after it is brought to the supercritical state; a component not in a supercritical state may also be provided into a cleaning chamber while the substrate is being exposed to a supercritical fluid, and additives or additional solvents may be introduced at various points within the process.

The removal capacity of a supercritical fluid can be further enhanced by removing the supercritical fluid from the supercritical state at a rate sufficient to result in bubble formation. For example, after some time has elapsed after exposure to the supercritical fluid liquid, a valve in the vessel is opened, substantially instantaneously, in order to relieve the gas pressure. The sudden drop in gas pressure causes the dissolved gas in the liquid to form bubbles. Since the formation of a gas bubble in the liquid will require a nucleus around which a gas can form, particles immersed in the liquid will serve as nuclei for bubble formation. As bubbles form around the particles in the liquid and grow in size, the buoyant force will increase. Eventually the bubble will detach from the surface and ascend in the liquid, carrying the particle with it to the top of the liquid surface. By this means, the particles will be detached from the surface of the object to be cleaned and congregate at the surface of the liquid.

Solvation Fluids

Removal of at least a portion of a polar fluid present on the surface of a substrate is accomplished using a supercritical fluid referred to herein as a solvation fluid. The term “solvation fluid,” as used herein, refers to a fluid that has a capacity to solvate a polar fluid present on the surface of a substrate when used according to the methods of the invention, while having the further property of being readily removed from the surface of the substrate without leaving a significant residue. The solvation fluid will generally include at least one oxygen-containing organic compound. By oxygen-containing, it is meant that the compound contains at least one oxygen atom. Further, an organic compound, as defined herein, contains both carbon and hydrogen. Thus, CO₂, according to the definition used herein, is not an organic compound as it lacks hydrogen. Preferred oxygen-containing organic compounds are organic relatives of water such as low molecular weight alcohols and ethers. While not intending to be bound by theory, ethers and alcohols are particularly preferred, as the have a bonding structure similar to water. This similarity, in turn, increases the affinity of these compounds for polar fluids such as water, making them more effective as cleaning agents. An alcohol, as defined herein, is an organic compound including a carbon bearing a hydroxyl group as its sole functional group, while an ether, as defined herein, is an organic compound including an oxygen atom that is bound to two different carbon atoms. In one embodiment of the invention, the oxygen-containing organic compounds include ethanol, methanol, and ethyl ether. In a preferred embodiment of the invention, the oxygen-containing organic compound is ethyl ether.

Solvation fluids are used to remove a polar fluid or fluids from the surface of a substrate. A “polar fluid,” as defined herein, is a material that exists in liquid form at room temperature, has a molecular weight of 500 or less, and has a dipole moment μ greater than 1.5 debyes. The bond dipole moment between two atoms is derived from the magnitude of the overall charge and distance separating the centers of charge, while overall dipole moment of a molecule is the vector sum of the individual bond dipole moments. For example, water is a preferred polar fluid that can be removed using solvation fluids used according to the method of the invention, and has a dipole moment of 1.84 debyes. Water is also a preferred polar fluid for removal by the present invention as it is typically present in large quantities during integrated circuit wafer manufacturing, and does not readily evaporate due to hydrogen bonding. Another example of a polar fluid is chloromethane, which has a dipole moment of 1.86 debyes. Carbon tetrachloride, on the other hand, is a symmetrical molecule with a dipole moment of 0 and is thus not considered a polar fluid.

Cleaning Fluids

Removal of at least a portion of a waste material present on the surface of a substrate is accomplished using a supercritical fluid referred to herein as a cleaning fluid. The term “cleaning fluid,” as used herein, refers to a fluid that has a capacity to dissolve or dislodge a waste material present on the surface of a substrate when used according to the methods of the invention. As the cleaning fluid is a supercritical fluid, the term fluid is not used to imply a liquid, but rather may be either a gas or liquid that can become supercritical under the appropriate conditions. The cleaning fluid should be a fluid that can be readily brought to the supercritical state, and includes liquids and gases such as carbon dioxide, nitrous oxide, ethane, ethylene, propane, and xenon.

Waste materials, as defined herein, include a large number of undesired contaminants that may be present on the surface of the substrate. For example, resist material, photoresist residue, organic residues, carbon-fluorine containing polymers such as those resulting from oxide etching processes or plasma etch processes, and organic impurities from other processes, may be removed according to the present invention. Such compositions and methods are particularly beneficial for removing ion implanted resist, UV hardened resist, X-ray hardened resist and resist in submicrometer grooves or crevices. Waste material may be present in significant quantities, or it may be present as small, scattered particulate matter that remains adhered to the surface of the substrate by forces such as Van der Walls or electrostatic forces.

Types of Substrates

The methods and compositions of the invention are used to clean the surface of a substrate. As used herein, the term substrate refers to an object or device bearing surfaces that may be cleaned by the methods and compositions of the invention. The cleaning methods and compositions of the invention are particularly suitable for small, complex structures with finely detailed geometries. In a preferred embodiment, the substrate is a microelectronic substrate. Microelectronic substrates include integrated circuits, micro-electro mechanical devices (MEMS), optoelectronic devices, photonic devices, flat panel displays, etc. Typically, the microelectronic substrate is a semiconductor-based structure that can be etched or have organic material or layers that are removed during assembly of the structure. Semiconductor materials include silicon, gallium arsenide, etc.

The microelectronic substrate can be a single layer of material, such as, for example, a silicon wafer, or can include any number of other layers. The microelectronic substrate includes devices made using silicon-on-sapphire technology, silicon-on-insulator technology, doped and undoped semiconductors, epitaxial layers of silicon supported by a base semiconductor, as well as other semiconductor-based structures, including any number of layers, as is well known to those skilled in the art. In addition to single devices, the methods and compositions of the invention are also suitable for cleaning the surface of a substrate array made up of a number of individual substrates. A substrate array including a number of individual integrated circuit devices is also referred to as an integrated circuit wafer.

Substrate Surface Characteristics

The methods and compositions of the invention are also useful for cleaning substrates bearing a surface including a porous material. The porous material may be characterized by the number and size of cells distributed therein. A cell, as referred to herein, refers to an enclosed region of gas (e.g. air). The size of a cell is determined by the nominal diameter of the enclosed region of gas. Porous materials with cell sizes of at most about 0.3 micron may be cleaned using the methods and compositions of the invention. Substrates with larger and smaller average cells sizes may be cleaned as well. Porous materials used with microelectronic substrates generally have small cell sizes so that the foamed material can be utilized to cover extremely small parts and spaces.

The methods and compositions of the invention are also useful for cleaning substrates bearing a polymeric surface. Polymers are chemical compounds comprising linked monomers that may or may not be linear, crosslinked, or thermosetting. Preferably, the polymeric surface is foamed to provide a foamed polymeric surface. Exemplary polymeric materials that can be used to provide foamed polymers include polyimides, polybenzocyclobutene, parylene, organic polysilica polymers, and various fluorinated polymers. Foamed polymeric material may be used on substrates in embodiments of the invention to provide a lower dielectric constant insulating material. Foamed polymeric material behaves as a matrix for porous structures containing air. By containing air, the foamed polymeric material combines the minimal dielectric constant of air, 1.0 ε₀, with the mechanical strength of the polymeric material. The lower dielectric constant of such foamed polymeric material allows its advantageous use in ICs where capacitive coupling has typically been problematic. This is useful to insulate adjacent conductive layers in small integrated circuits.

The use of foamed polymeric material in microelectronic devices provides several advantages. For example, unlike conventional SiO₂, which has a dielectric constant of about 4.0 ε₀, the polymeric matrix materials utilized to provide porous insulating material preferably have dielectric constants of about 3.0 ε₀ or less, depending on the percentage of voids within the material and the dielectric constant of the polymeric matrix material. Preferably, foamed polymer materials have cell sizes of at most about 0.3 microns. For further discussion of foamed polymers used as insulating material for integrated circuits, see U.S. Pat. No. 6,107,357, issued to Hawker et al, and U.S. Pat. No. 6,734,562, issued to Farrar.

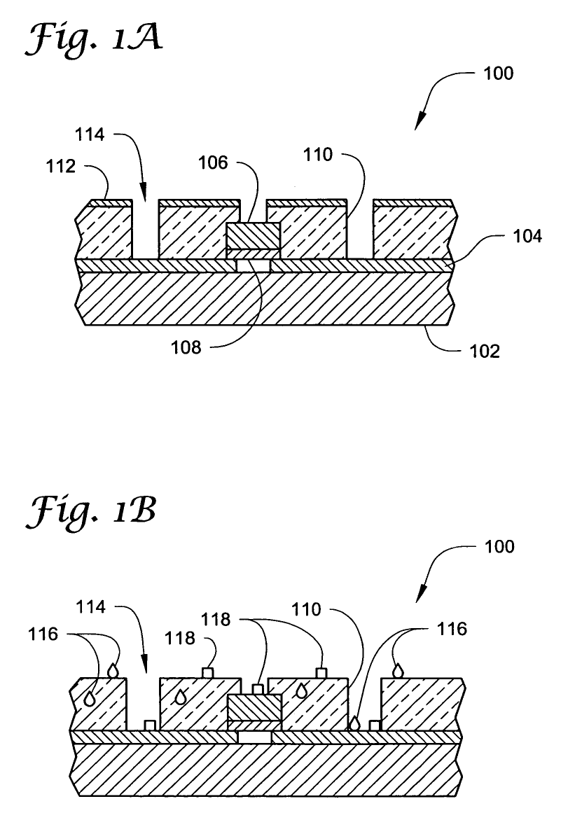

An example of a foamed polymeric surface on an integrated circuit that may be cleaned by methods of the present invention is shown in FIG. 1A. The integrated circuit may include a variety of components, such as capacitative trenches and transistors. For example, FIG. 1A shows the region around an integrated circuit transistor 100. The transistor 100 is laterally isolated on a doped silicon wafer 102. Implanted source/drain regions 104 are formed in the doped silicon wafer 102 on either side of a gate 106 and gate oxide 108 stack. A layer of foamed polymeric material 110 is provided over the gate 106, source/drain regions as formed in layer 104, of the doped silicon wafer 102.

The foamed polymeric material 110 be patterned by conventional photolithography and etching processes. A resist layer 112 (e.g., photoresist) is typically found coating the foamed polymeric material 110, as well known to one skilled in the art. The resist layer 112 is exposed (e.g., utilizing photolithography) and developed, as well known to one skilled in the art, resulting in a patterned layer including resist 112 on the underlying foamed polymeric material 110. The foamed polymeric material 110 may be etched using suitable etch chemistries for the polymeric material 110. For example, most organic polymers can be etched using an oxygen plasma. After the etching, a throughhole 114 extends through both the resist 112 and the foamed polymeric material 110 to the underlying substrate 102. Note that while FIG. 1A illustrates a transistor including a foamed polymeric material 110 insulator, this is an example only and a wide variety of other configurations, such as trench capacitors, exist that may be cleaned using the method of the invention.

When no longer needed, the resist layer 112 may be removed by use of standard photoresist removal methods, such as wet or dry photoresist stripping. These removal processes may leave a wide variety of waste materials 1118 and/or polar fluids 116 scattered about on the surface of the substrate, which in FIG. 1B is a foamed polymeric material 110, and particularly within the throughholes 114 where it may be difficult to remove. When the surface is porous, waste material 118 and/or polar fluids 116 may also be trapped within pores, making it even more difficult to remove. Traditional cleaning methods often use de-ionized water or other polar fluids, which may diminish the effectiveness of the dielectric layer and effectively replace one waste material with another.

Methods of removing Polar Fluids from a Substrate Surface

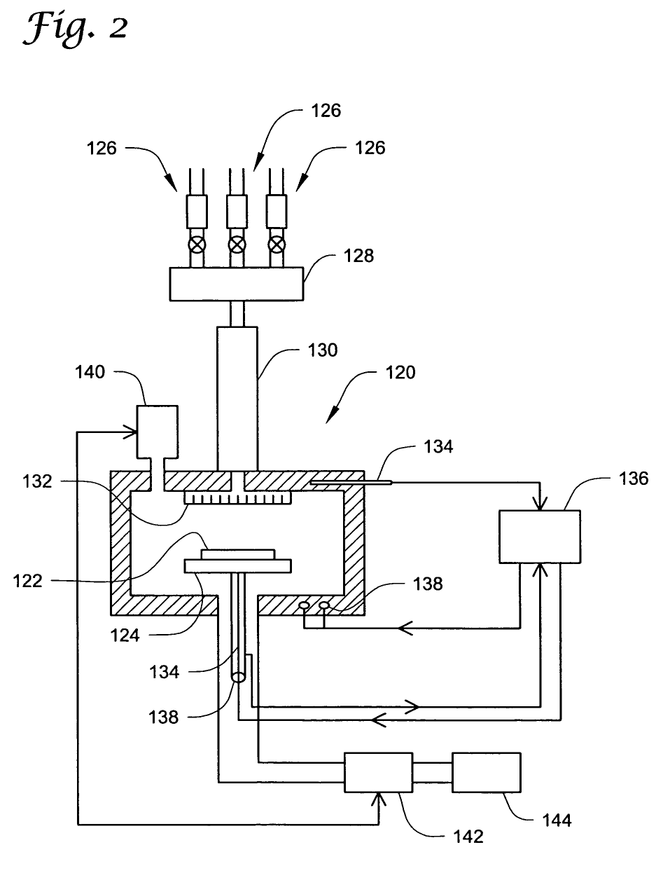

The method of cleaning a substrate using a solvation fluid to remove a polar fluid or fluids from the surface of the substrate is generally carried out in a pressure vessel 120 such as that shown in FIG. 2. The pressure vessel 120 is used to allow the environment around the substrate 122 to attain supercritical conditions of temperature and pressure. The substrate 122 is placed in the pressure vessel, and a solvation fluid is introduced. The solvation fluid is preferably delivered through a dispensing vessel 132 and then heated and compressed to the conditions necessary for at least one compound in the solvation fluid to enter the supercritical state. For example, if the oxygen-containing organic compound in the solvation fluid is ethanol, the temperature should be raised to at least 243° C. and the pressure to 63 atmospheres or more to place the ethanol into its supercritical state. Temperature and pressure are regulated during stripping and cleaning of the substrate 122 using the temperature control 136 and the pressure control 140 units to keep the cleaning fluid in a supercritical state.

After sufficient time has passed for at least a portion of a polar fluid present on the surface of the substrate to be removed, the fluids within the pressure chamber may be removed from the pressure vessel 120 using the pumping system 144. If desired, portions of the fluid within the pressure vessel may also be removed during cleaning to effect a continuous cleaning process in which fluid that has been contaminated with waste material 118 is withdrawn and replaced with fresh, uncontaminated fluid. In a preferred embodiment, the pressure and/or temperature within the pressure vessel 120 is decreased rapidly to induce bubble formation, which may further enhance cleaning as described. After at least a portion of the polar fluids have been removed from the substrate, the substrate is preferably dried. For example, for substrates such as an integrated circuit wafer, spin drying may be used to rapidly dry the substrate.

An additional embodiment of the method of removing polar fluids from substrate surfaces using supercritical solvation fluids uses sonic energy to enhance the cleaning process. Application of sonic energy to the substrate and/or supercritical fluid is useful to further assist in removing particles and or polar fluids from the substrate surface by disrupting existing bonding between to substrate and associated materials. Sonic energy may be applied to provide either ultrasonic or megasonic cleaning, depending on the nature of the cleaning necessary.

Supplemental Ultrasonic and Megasonic Cleaning

In ultrasonic cleaning, the substrate and/or supercritical fluid is sonicated or agitated at a high frequency (e.g., 18 to 120 kilohertz). This is typically continued for several minutes. Ultrasonic cleaning uses cavitation to facilitate cleaning of a surface. Cavitation occurs when microscopic bubbles form in the liquid medium and then violently collapse or implode, mechanically scouring the substrate being cleaned and displacing and loosening the waste materials or polar fluids present. Supplemental ultrasonic cleaning provides many advantages. It is fast, effective and safe to use, requires less heat than other cleaning methods, and when used properly it can vigorously clean parts without harming surface finishes. The devices used to apply ultrasonic energy also have the advantage of not requiring the dismantling of assemblies after use. Ultrasonic cleaning is not used in the manufacturing of high-density ULSI semiconductors because of the possibility of damage to the fragile structures.

Megasonic cleaning includes the same steps as ultrasonic cleaning, but while ultrasonic frequencies range from about 18 to 120 kilohertz, megasonic frequencies are in the range of about 0.8 to 1 megahertz, with input power densities ranging from 5 to 10 watts per centimeter. Whereas the cleaning action in ultrasonic cleaning comes from cavitation, the cleaning action in megasonic cleaning comes from high pressure waves pushing and tugging at material associated with the substrate's surface. Supplemental megasonic cleaning provides many advantages. It rarely causes scratches, breakage or chipping, since substrates are not transferred or subjected to any mechanical stress. Furthermore, it is three to four times more productive than scrubbing or chemical cleaning at an equal or lower investment cost, and produces superior wafer cleanliness.

Removal of Waste Materials using Supercritical Cleaning Fluid after Wet Stripping

Prior to removal of polar fluids (e.g., water), it may be preferable to remove waste materials from the surface of the substrate. Waste materials may be removed using a supercritical stripping fluid together with a cleaning fluid; i.e. a wet stripping process, or waste materials may be removed using a gaseous plasma together with a supercritical fluid; i.e. a dry stripping process. These cleaning processes often leave a surface that remains contaminated with polar fluids suitable for application the cleaning process using supercritical salvation fluids already described.

An etching and cleaning process may utilize an apparatus that is customized for the particular supercritical etching composition being used. For example, the pressure vessel 120 of FIG. 2 represents a device useful for exposing a substrate 122 to the stripping and/or supercritical fluid composition. The pressure vessel 120 includes a chuck 124 for supporting and/or rotating the substrate 122. Mass or liquid flow controllers 126 control the input of each component introduced into the pressure vessel 120 when multiple components are used. For example, a supercritical component (prior to being brought to the supercritical state) and a nonsupercritical component (if used) may each enter the pressure vessel 120 directly through a separate controller 126.

As further illustrated in FIG. 2, components can be pre-mixed in a mixing manifold 128. The components can also be brought to the supercritical state in the mixing manifold 128 by including heating coils or vanes in the manifold 128 walls to increase heat transfer to the components before passing through an optional circulation heater 130. The supercritical etching composition then enters the pressure vessel 120 through a dispensing device 132 (e.g., a shower-head). The stripping or cleaning fluid is delivered to the substrate 122 from the dispensing device 132. It is also to be understood that the stripping or cleaning fluid can be delivered to the substrate 122 from a heated transfer line without using a dispensing device 132.

Temperature and pressure within the pressure vessel 120 should be at or above the critical temperature and pressure for the supercritical component during the cleaning. The stripping fluid may dissolve in the supercritical cleaning fluid as a non-supercritical component, or may itself be in the supercritical state, depending on the temperature and pressure within the pressure vessel 120. A temperature sensor 134 (e.g., thermocouple) monitors temperature within the pressure vessel 120 and relays an appropriate signal to a temperature control unit 136. The temperature control unit 136 sends appropriate signals to heater inputs 138, which provide heat to the pressure vessel 120. A pressure gauge 140 is also used to monitor pressure within the pressure vessel 120 and send appropriate signals to a pressure control unit 142, which pressurizes/depressurizes the pressure vessel 120. Excess composition is vented or pumped out of the pressure vessel through a vent or pumping system 144. The supercritical etching composition passes from the pressure vessel 120 to the vent or pumping system 144 by operation of a pressure differential between adjacent chambers.

Using an appropriate apparatus, such as that shown in FIG. 2, the photoresist layer 112 may be removed from the surface of a substrate, creating a surface that includes waste material 118, such as that shown in FIG. 1B. To accomplish this, the substrate 122 is introduced into the pressure vessel 120, and stripping fluid is then delivered to the substrate through the dispensing vessel 132. The stripping fluid is preferably delivered at the appropriate temperature and pressure for rapid stripping of the photoresist; alternately, it may be delivered and then heated and compressed to the appropriate conditions. An appropriate period of time is then allowed for the photoresist layer 112 to be removed. A stripping fluid suitable for removal of photoresist is a mixture of H₂SO₄ and H₂O₂, also referred to in the literature as a “Piranha” solution. Following the use of a relatively harsh solution such as a “Piranha” solution, the substrate 122 may simply be washed with de-ionized water.

A cleaning fluid is then delivered to the substrate 122 within the pressure vessel 120 via the dispensing vessel 132. As with the stripping fluid, the cleaning fluid may be delivered at the appropriate temperature and pressure, or it may be raised to the appropriate temperature and pressure once it is within the pressure vessel 120. The cleaning fluid should be a fluid that can be readily brought to the supercritical state, and includes liquids and gases such as carbon dioxide, nitrous oxide, ethane, ethylene, propane, and xenon. The cleaning fluid may be delivered subsequent to removal of the stripping fluid, or the cleaning fluid may be delivered while the stripping fluid is still present within the pressure vessel 132, resulting in mixture of the two fluids. Temperature and pressure are regulated during stripping and cleaning of the substrate 122 using the temperature control 136 and the pressure control 140 units to keep the cleaning fluid in a supercritical state.

After sufficient time has elapsed to remove at least a portion of the waste material present on the surface of the substrate, the fluids within the pressure chamber may be removed from the pressure vessel 120 using the pumping system 144. If desired, portions of the fluid within the pressure vessel may also be removed during cleaning to effect a continuous cleaning process in which fluid that has been contaminated with waste material 118 is withdrawn and replaced with fresh, uncontaminated fluid. In a preferred embodiment, the pressure and/or temperature within the pressure vessel 120 is decreased rapidly to induce bubble formation, which may further enhance cleaning as described. The cleaning process may also be supplemented by delivery of sonic energy using the ultrasonic or megasonic energy, as described above. After the substrate has been cleaned, it should be dried. For example, for substrates such as an integrated circuit wafer, spin drying may be used to rapidly dry the substrate. Preferably, drying is followed by rinsing of the substrate in de-ionized water.

Removal of Waste Materials Using Supercritical Cleaning Fluid after Dry Stripping

Additional embodiments of the cleaning method use drying stripping to remove material from the surface of a substrate. When dry stripping is used, the method of cleaning the surface using supercritical fluids is generally varied to accommodate the nature of the stripping method and the type of waste material it tends to leave on the surface of the substrate. The first step in this process is for the material (e.g., photoresist) to be removed from the surface of the substrate by plasma stripping, using a highly plasma (e.g., O₂ plasma). Plasma stripping methods are well-known in the art. After the plasma strip, the substrate is may be placed in a pressure vessel 120 such as that shown in FIG. 2. The pressure vessel 120 is then filled with a cleaning fluid. The cleaning fluid should be a fluid that can be readily brought to the supercritical state, and includes liquids and gases such as carbon dioxide, nitrous oxide, ethane, ethylene, propane, and xenon. The substrate 122 is rinsed with de-ionized water, and the pressure and temperature in the pressure vessel 120 are then increased until the cleaning fluid enters the supercritical state. For example, if the cleaning fluid is CO₂, the temperature can be raised to 32° C. and the pressure to 73 atm to place the cleaning fluid in a supercritical state. Temperature and pressure are regulated using the temperature control 136 and the pressure control 140 units to keep the cleaning fluid in a supercritical state.

After holding the cleaning fluid in a supercritical state long enough to remove at least a portion of the waste material present on the surface of the substrate, the cleaning fluid is then returned to a non-supercritical state. The fluids within the pressure chamber are then removed from the pressure vessel 120 using the pumping system 144. If desired, portions of the fluid within the pressure vessel may also be removed during cleaning to effect a continuous cleaning process in which fluid that has been contaminated with waste material 118 is withdrawn and replaced with fresh, uncontaminated fluid. In a preferred embodiment, the pressure and/or temperature within the pressure vessel 120 is decreased rapidly to induce bubble formation, which may further enhance cleaning as described. The cleaning process may also be supplemented by delivery of sonic energy using the ultrasonic or megasonic energy, as described above. After the substrate has been cleaned, it should be dried. For example, for substrates such as an integrated circuit wafer, spin drying may be used to rapidly dry the substrate. Preferably, drying is followed by rinsing of the substrate in de-ionized water.

Additional embodiments of the invention include supplement cleaning using supercritical fluids with other methods, such as brush scrubbing and high pressure jet cleaning. In the brush scrubbing, a brush is used to assist in dislodging waste material from the substrate surface. Preferably, the brush never actually touches the surface being cleaned, and there is a film of the scrubbing solution between the brush and the surface. Brushes, which are generally hydrophilic, are better able to remove contaminants from hydrophobic surfaces. Surfaces that are hydrophilic are more difficult to clean because suspended contaminants can precipitate back onto them. High pressure jet cleaning is an additional supplemental cleaning method, in which a high velocity jet of liquid sweeping across a surface at pressures of 100 to 4,000 psi. It is effective for removing waster material when the shear force it exerts is greater than the adhesion force holding a material to a surface.

The following examples are meant to be illustrative of numerous embodiments of practicing the invention. They are meant to be understood as examples only, and not limiting on the scope of the invention.

### EXAMPLES

### Example 1

This example illustrates a process for removing water from a clean, porous surface. An integrated circuit wafer including a foamed polyimide as an insulating material is placed in pressure vessel, such as that shown in FIG. 2. The integrated circuit is then immersed in ethyl alcohol. The temperature and pressure within the cleaning chamber is then raised to above 234° C. and 63 atmospheres, respectively, to provide ethyl alcohol that is in the supercritical state. After a time, the pressure is then rapidly decreased and the chamber is allowed to cool. Once the chamber has cooled sufficiently, the remaining ethyl alcohol is removed and the wafers are dried.

### Example 2

This example illustrates a process in which wet stripping of photoresist is followed by removal of water. An integrated circuit wafer including a photoresist layer is exposed to a 5:1H₂SO₄/H₂O₂ solution (a “Piranha” solution) for 10 minutes at 125° C. in a CO₂ atmosphere. The pressure of the CO₂ is then raised to 73 atmospheres to provide a supercritical fluid. After a time, the pressure is rapidly decreased, and the wafer is then spun dry at 3,000 RPMs for 30 seconds. The wafer is then rinsed in de-ionized (18 Meg Ohm) water. Water present on the water is then removed using the water removal process described in Example 1.

### Example 3

This example illustrates a process in which dry stripping of photoresist is followed by removal of water. An integrated circuit wafer including a photoresist layer is exposed to a plasma strip process at 2500 W for 10 seconds, using a 5% O₂, 95% N₂ gas mixture. The integrated circuit wafer is then rinsed with de-ionized water (18 Meg ohm) in a CO₂ atmosphere at room temperature (18-23° C.). The wafer is retained in a CO₂ atmosphere, which is converted to a supercritical state by increasing the temperature to 32° C. and the pressure to 73 atm., from 30 minutes to three hours, depending upon the materials used. After a time, the pressure is rapidly decreased and the wafer is dried by spin drying at 3,000 RPMs for 30 seconds. The wafer is then rinsed again in de-ionized (18 Meg Ohm) water. Water is then removed from the wafer using the water removal process described in Example 1.

The complete disclosure of all patents, patent applications, and publications, and electronically available material cited herein are incorporated by reference in their entirety, as if individually incorporated. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

All headings are for the convenience of the reader and should not be used to limit the meaning of the text that follows the heading, unless so specified.

What is claimed is:

1. A method of cleaning a surface of a substrate, comprising:
contacting the substrate with a solvation fluid comprising an oxygen-containing organic compound in a supercritical state; and
returning the oxygen-containing organic compound to a non-supercritical state to remove at least a portion of a polar fluid present on the surface of the substrate.

2. The method of claim 1, wherein the surface comprises a porous material.

3. The method of claim 2, wherein the porous material has a maximum cell size of at most about 0.3 microns.

4. The method of claim 1, wherein the surface comprises a polymer layer.

5. The method of claim 4, wherein the polymer layer comprises a foamed polymer.

6. The method of claim 1, wherein the substrate is a microelectronic substrate.

7. The method of claim 1, wherein the oxygen-containing organic compound is returned to a non-supercritical state by reducing its pressure.

8. The method of claim 1, wherein the oxygen-containing organic compound is returned to a non-supercritical state by reducing its temperature.

9. The method of claim 1, wherein the oxygen-containing organic compound comprises an alcohol or an ether.

10. The method of claim 1, wherein the oxygen-containing organic compound comprises ethyl alcohol, methyl alcohol, or ethyl ether.

11. The method of claim 1, wherein the oxygen-containing organic compound comprises ethyl alcohol.

12. The method of claim 1, wherein the polar fluid comprises water.

13. The method of claim 1, further comprising drying the surface of the substrate after returning the oxygen-containing organic compound to a non-supercritical state.

14. The method of claim 1, further comprising delivering sonic wave energy to the substrate.

15. A method of cleaning a porous surface of a microelectronic substrate, comprising:
contacting the microelectronic substrate with a solvation fluid comprising an oxygen-containing organic compound in a supercritical state; and
returning the oxygen-containing organic compound to a non-supercritical state to remove at least a portion of a polar fluid present on the porous surface of the microelectronic substrate.

16. The method of claim 15, wherein the oxygen-containing organic compound comprises ethyl alcohol, methyl alcohol, or ethyl ether.

17. A method of cleaning a surface of a substrate, comprising:
placing the substrate in contact with a stripping fluid;
contacting the substrate or stripping fluid with cleaning fluid in a supercritical state;
returning the cleaning fluid to a non-supercritical state to remove at least a portion of a waste material present on the surface of the substrate;
contacting the substrate with a solvation fluid comprising an oxygen-containing organic compound in a supercritical state; and
returning the oxygen-containing organic compound to a non-supercritical state to remove at least a portion of a polar fluid present on the surface of the substrate.

18. The method of claim 17, wherein the cleaning fluid comprises carbon dioxide, ethane, ethylene, nitrous oxide, propane, or xenon.

19. The method of claim 17, wherein the stripping fluid comprises sulfuric acid solution, hydrogen peroxide solution, or de-ionized water.

20. The method of claim 17, wherein the substrate is dried before contacting the substrate with a solvation fluid.

21. The method of claim 17, wherein the surface comprises a porous material.

22. The method of claim 21, wherein the porous material has a maximum cell size of at most about 0.3 microns.

23. The method of claim 17, wherein the surface comprises a polymer layer.

24. The method of claim 23, wherein the polymer layer comprises a foamed polymer.

25. The method of claim 17, wherein the substrate is a microelectronic substrate.

26. The method of claim 17, wherein the oxygen-containing organic compound is returned to a non-supercritical state by reducing its pressure.

27. The method of claim 17, wherein the oxygen-containing organic compound is returned to a non-supercritical state by reducing its temperature.

28. The method of claim 17, wherein the oxygen-containing organic compound comprises an alcohol or an ether.

29. The method of claim 17, wherein the oxygen-containing organic compound comprises ethyl alcohol, methyl alcohol, or ethyl ether.

30. The method of claim 17, wherein the oxygen-containing organic compound comprises ethyl alcohol.

31. The method of claim 17, wherein the polar fluid comprises water.

32. The method of claim 17, further comprising delivering sonic wave energy to the substrate.

33. A method of cleaning a porous surface of a microelectronic substrate, comprising:
placing the microelectronic substrate in contact with a stripping fluid;
contacting the substrate or the stripping fluid with cleaning fluid in a supercritical state;
returning the cleaning fluid to a non-supercritical state to remove at least a portion of a waste material present on the porous surface of the microelectronic substrate;
drying the microelectronic substrate;
contacting the microelectronic substrate with a solvation fluid comprising an oxygen-containing organic compound in a supercritical state; and
returning the oxygen-containing organic compound to a non-supercritical state to remove at least a portion of a polar fluid present on the porous surface of the microelectronic substrate.

34. The method of claim 33, wherein the cleaning fluid comprises carbon dioxide, ethane, ethylene, ethylene, nitrous oxide, propane, or xenon.

35. The method of claim 33, wherein the stripping fluid comprises sulfuric acid solution, hydrogen peroxide solution, or de-ionized water.

36. A method of cleaning a surface of a substrate, comprising:
contacting the substrate with a gaseous plasma;
contacting the substrate with cleaning fluid in a supercritical state;
returning the cleaning fluid to a non-supercritical state to remove at least a portion of a waste material present on the surface of the substrate;
contacting the substrate with a solvation fluid comprising an oxygen-containing organic compound in a supercritical state; and
returning the oxygen-containing organic compound to a non-supercritical state to remove at least a portion of a polar fluid present on the surface of the substrate.

37. The method of claim 36, wherein the gaseous plasma comprises an oxidizer selected from the group consisting of SO₂, N₂O, NO, NO₂, O₃, H₂O₂, F₂, Cl₂, Br₂, and O₂.

38. The method of claim 36, wherein the surface comprises a porous material.

39. The method of claim 38, wherein the porous material has a maximum cell size of at most about 0.3 microns.

40. The method of claim 36, wherein the surface comprises a polymer layer.

41. The method of claim 40, wherein the polymer layer comprises a foamed polymer.

42. The method of claim 36, wherein the substrate is a microelectronic substrate.

43. The method of claim 36, wherein the oxygen-containing organic compound is returned to a non-supercritical state by reducing its pressure.

44. The method of claim 36, wherein the oxygen-containing organic compound is returned to a non-supercritical state by reducing its temperature.

45. The method of claim 36, wherein the oxygen-containing organic compound comprises an alcohol or an ether.

46. The method of claim 36, wherein the oxygen-containing organic compound comprises ethyl alcohol, methyl alcohol, or ethyl ether.

47. The method of claim 36, wherein the oxygen-containing organic compound comprises ethyl alcohol.

48. The method of claim 36, wherein the polar fluid comprises water.

49. The method of claim 36, further comprising delivering sonic wave energy to the substrate.

50. A method of cleaning a porous surface of a microelectronic substrate, comprising:
contacting the microelectronic substrate with a gaseous plasma;
contacting the microelectronic substrate with cleaning fluid in a supercritical state;
returning the cleaning fluid to a non-supercritical state to remove at least a portion of a waste material present on the porous surface of the microelectronic substrate;
contacting the microelectronic substrate with a solvation fluid comprising an oxygen-containing organic compound in a supercritical state; and
returning the oxygen-containing organic compound to a non-supercritical state to remove at least a portion of a polar fluid present on the polar surface of the microelectronic substrate.

51. The method of claim 50, wherein the gaseous plasma comprises an oxidizer selected from the group consisting of SO₂, N₂O, NO, NO₂, O₃, H₂O₂, F₂, Cl₂, Br₂, and O₂.

52. A composition comprising a microelectronic substrate or microelectronic substrate assembly in contact with a solvation fluid comprising an oxygen-containing organic compound in a supercritical state.

53. The composition of claim 52, wherein the oxygen-containing organic compound comprises an alcohol or an ether.

54. The composition of claim 52, wherein the oxygen-containing organic compound comprises ethyl alcohol, methyl alcohol, or ethyl ether.

55. The composition of claim 52, wherein the oxygen-containing organic compound comprises ethyl alcohol.

56. The composition of claim 52, wherein the microelectronic substrate comprises a foamed polymer.

57. The composition of claim 56, wherein the foamed polymer has a maximum cell size of at most about 0.3 microns.
